(19) United States
(12) Patent Application Publication
(10) Pub. No.: US 2006/0221567 A1
(43) Pub. Date: Oct. 5, 2006

(54) Latch mechanism for portable computer

(75) Inventors: Jie Zhang, Shenzhen (CN); Ke-Cheng Lin, Tu-Cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/359,182

(22) Filed: Feb. 22, 2006

(30) Foreign Application Priority Data
Mar. 31, 2005 (CN) 200510033947.3

(51) Int. Cl. G06F 1/16

(52) U.S. Cl. 361/683

(57) ABSTRACT

A latch mechanism assembly includes a cover unit (30), a base unit (50), a latch (60) and an elastic member (70). The cover unit (30) includes a pair of spaced plates (312, 313), and each of the plates (312, 313) defines a hole (315, 316) therein. A latching slot (51) is defined in the base unit (50). The latch (60) is slideably fixed between the plates (312, 313) of the cover unit (30), the latch (60) includes a hook (61) to enter the latching slot (51) to engage in the base unit (50), and a pair of fixing members (65, 66) extends from two ends of the latch (60) to engage in corresponding holes (315, 316) of the plates (312, 313). The elastic member (70) is connected with one fixing member (65) of the latch (60) for restoring the latch (60).

### BACKGROUND OF THE INVENTION

1. Field of the Invention

The present invention relates to a latch mechanism, and particularly to a latch mechanism for a portable computer.

2. General Background

Typically, an electronic device, such as a portable computer, includes a cover unit and a base unit pivotally connected with the cover unit, and a latch mechanism is provided to lock the cover unit to the base unit.

As disclosed in Taiwan Patent No. 482309, a latch mechanism for locking a cover unit to a base unit, includes a latch, a spring for restoring the latch and a fixing portion. The latch includes a main body, a hook, an engaging portion, and a rod extending from the main body. The fixing portion includes a fixing plate, and a receiving groove is defined between the fixing plate and a sidewall of the cover unit for receiving the latch. A stop plate is formed from an end of the groove, and a recess is defined in the stop plate for receiving the rod of the latch. A sliding slot is defined in the fixing panel, and the engaging portion of the latch is extended through the sliding slot to engage the fixing portion. However, the structure of the latch mechanism is complicated, and it is discommodious to assemble or disassemble the latch mechanism.

What is desired, therefore, is a latch mechanism which is simple and low cost, and is able to be fixed in a portable computer conveniently.

### SUMMARY

In one preferred embodiment, a latch mechanism assembly includes a cover unit, a base unit, a latch and an elastic member. The cover unit includes a pair of spaced plates, and each of the plates defines a hole therein. A latching slot is defined in the base unit. The latch is slideably fixed between the plates of the cover unit, the latch includes a hook to enter the latching slot to engage in the base unit, and a pair of fixing members extends from two ends of the latch to engage in corresponding holes of the plates. The elastic member is connected with one fixing member of the latch for restoring the latch.

Other advantages and novel features will become more apparent from the following detailed description of a preferred embodiment when taken in conjunction with the accompanying drawings, in which:

### BRIEF DESCRIPTION OF THE DRAWINGS

FIG. 1 is an exploded, isometric view of a latch mechanism with a cover unit and a base unit in accordance with a preferred embodiment of the present invention;

FIG. 2 is an enlarged isometric view of the latch mechanism and a first panel of the cover unit of FIG. 1, but viewed in another aspect;

FIG. 3 is an assembled view of FIG. 2, but viewed in another aspect;

FIG. 4 is similar to FIG. 3, showing another state of the latch mechanism;

FIG. 5 is an assembled and part sectioned view of FIG. 1, showing the cover unit is closed to the base unit; and

FIG. 6 is an enlarged isometric view of a circled portion VI of FIG. 5.

### DETAILED DESCRIPTION OF THE EMBODIMENT

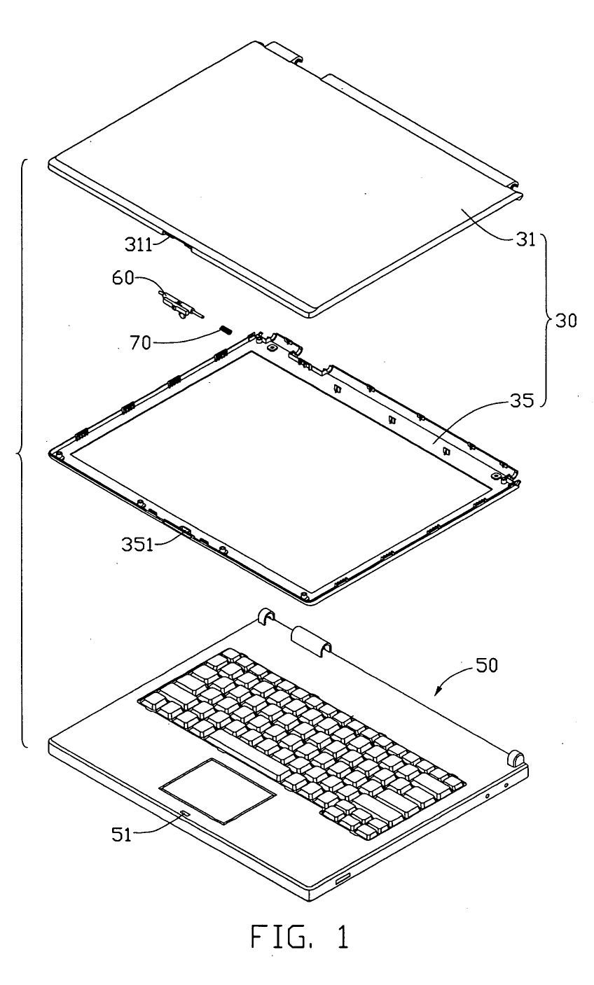

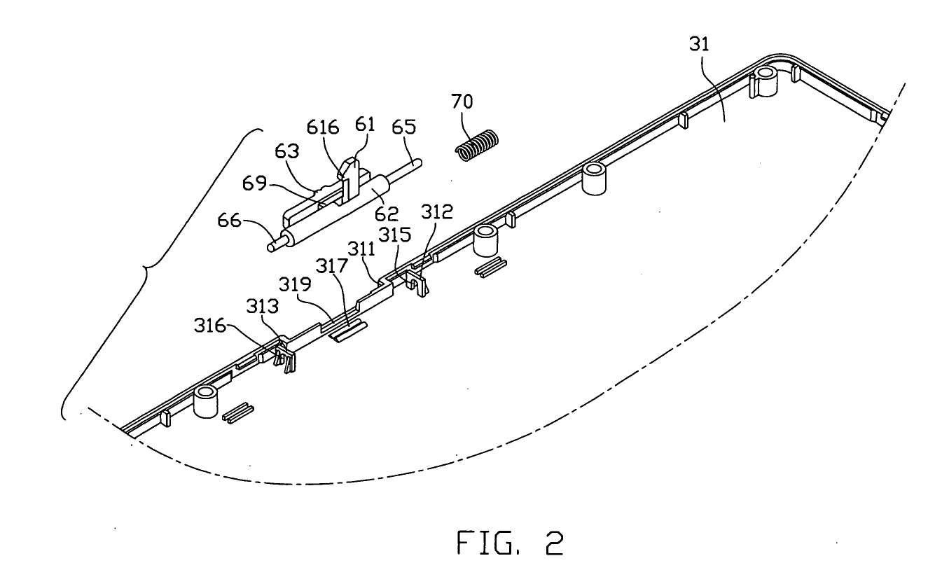

Referring to FIGS. 1 and 2, a latch mechanism is provided in accordance with the preferred embodiment of the present invention for locking a cover unit 30 to a base unit 50 of an electronic device, such as a portable computer. The latch mechanism includes a latch 60 and an elastic member 70. In this embodiment, the elastic member 70 is preferably a spring.

The cover unit 30 includes a first panel 31 and a second panel 35. A sliding recess 311 is defined in a front edge of the first panel 31, and a notch 319 is defined in the sliding recess 311. A pair of spaced plates 312, 313 each defining a hole 315, 316 therein is formed from an internal side of the first panel 31 adjacent to the sliding recess 311, and a pair of semicolumn positioning blocks 317 parallel with the sliding recess 311 is formed between the plates 312, 313. A through hole 351 is defined in the second panel 35.

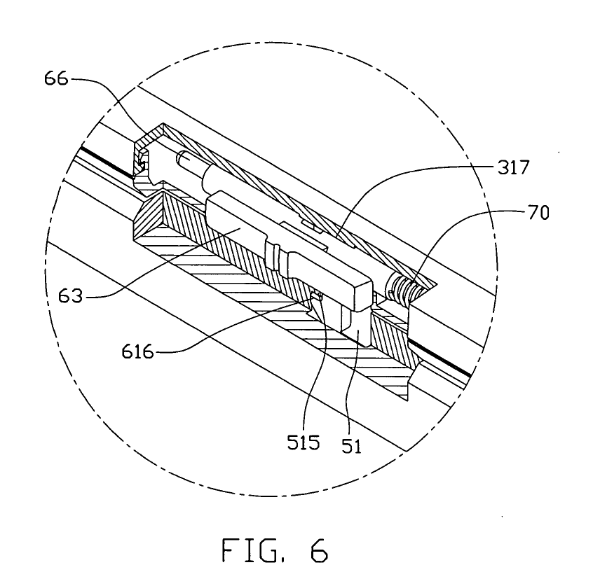

The base unit 50 includes a latching slot 51, and an engaging portion 515 is formed from the latching slot 51 (referring to FIG. 6).

The latch 60 includes a cylindrical main body 62. A hook 61 with a hooking portion 616 protrudes from a middle portion of the main body 62, corresponding to the through hole 351 of the second panel 35. A pair of fixing members 65, 66 extends from two opposite ends of the main body 62, corresponding to the holes 315, 316 of the plates 312, 313. An operating member 63 extends from the middle portion of the main body 62, corresponding to the sliding recess 311. A bridge 69 is formed between the operating member 63 and the main body 62. In this embodiment, the fixing members 65, 66 are preferably rods.

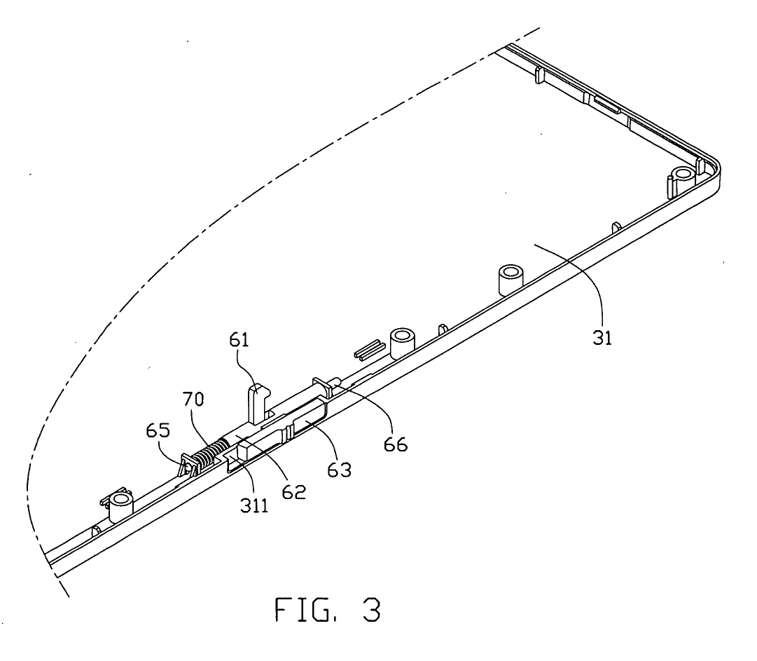

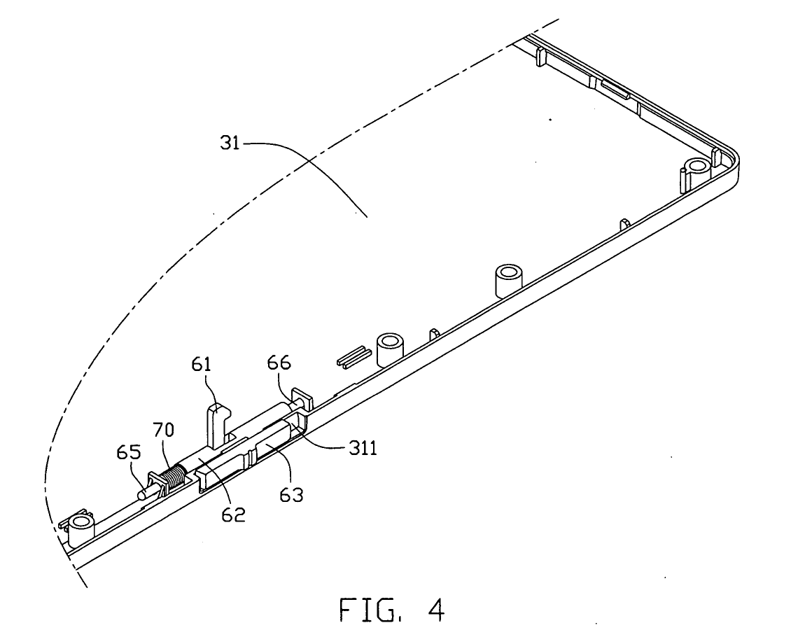

Referring to FIGS. 3 and 4, in assembly, the fixing member 65 is extended through the hole 315 of the plate 312 of the first panel 31, with the fixing member 65 of the latch 60 received in the elastic member 70. Two free ends of the elastic member 70 respectively engage with the plate 312 and the main body 62 of the latch 60. Pushing the latch 60 toward the plate 312, the elastic member 70 is compressed until the fixing member 66 aligns with the hole 316 of the plate 313. Releasing the latch 60, the elastic member 70 is restored to push the fixing member 66 to be extended through the hole 316 of the plate 313, thereby the latch 60 is received between the plates 312, 313 of the first panel 31, and is placed on the positioning blocks 317 and capable of sliding along the positioning blocks 317 by means of linear contact therebetween.

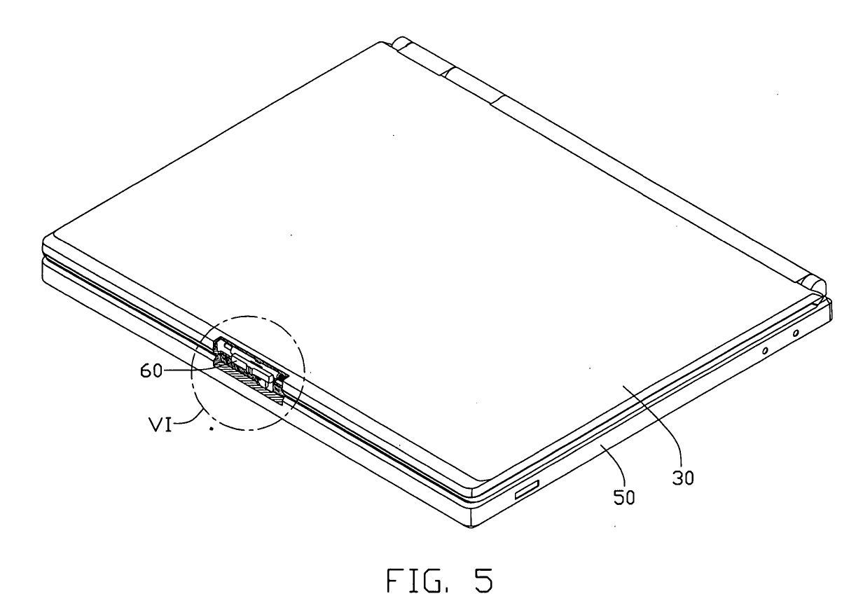

Referring also to FIGS. 5 and 6, the second panel 35 is fixed to the first panel 31 to form the cover unit 30, and the hook 61 of the latch 60 protrudes outward from the through hole 351 of the second panel 35.

The cover unit 30 is pivotally attached to the base unit 50, and then the cover unit 30 is folded to the base unit 50. When the hooking portion 616 of the hook 61 abuts against the engaging portion 515 of the latching slot 51, the latch 60 is pushed to compress the elastic member 70, and the latch 60 is slid toward the plate 312 until the hooking portion 616 entirely enters the latching slot 51. The elastic member 70 is restored and pushes the latch 60 toward the plate 313, with the hooking portion 616 engaging in the base unit 50 under the engaging portion 515, thereby the cover unit 30 is locked to the base unit 50.

Referring back to FIG. 4, to open the cover unit 30 from the base unit 50, the operating member 63 is pushed toward the plate 315 until the hooking portion 616 disengages the engaging portion 515 and exits from the latching slot 51, thereby the cover unit 30 is opened from the base unit 50.

It is believed that the present embodiment and its advantages will be understood from the foregoing description, and it will be apparent that various changes may be made thereto without departing from the spirit and scope of the invention or sacrificing all of its material advantages, the example hereinbefore described merely being preferred or exemplary embodiment.

What is claimed is:

1. A latch mechanism assembly, comprising:
a cover unit comprising a pair of spaced plates, and each of the plates defining a hole therein;
a base unit defining a latching slot therein;
a latch slideably fixed between the plates of the cover unit, the latch comprising a hook to enter the latching slot to engage in the base unit, and a pair of fixing members extending from two ends of the latch to engage in corresponding holes of the plates; and
an elastic member connected with one fixing member of the latch for restoring the latch.

2. The latch mechanism assembly as claimed in claim 1, further comprising an operating member extending from the latch for driving the latch to slide between the plates, and a sliding recess is defined in the cover unit for receiving the operating member.

3. The latch mechanism assembly as claimed in claim 1, wherein the cover unit comprises a first panel and a second panel, a through hole is defined in the second panel corresponding to the hook of the latch.

4. The latch mechanism assembly as claimed in claim 1, wherein the elastic member receives said one fixing member therein, and two free ends of the elastic member respectively engage with the corresponding plate and the latch.

5. The latch mechanism assembly as claimed in claim 1, wherein the fixing member is a rod.

6. The latch mechanism assembly as claimed in claim 1, wherein the elastic member is a spring.

7. The latch mechanism assembly as claimed in claim 1, wherein an engaging portion is formed from the latching slot of the base unit for engaging the hook of the latch.

8. A latch mechanism for locking a cover unit to a base unit with a latching slot therein, comprising:
a pair of spaced plates formed from the cover unit, and each of the plates defining a hole therein;
a latch slideably fixed between the plates of the cover unit, the latch comprising a hook and a pair of fixing members, the fixing member extending from two ends of the latch to engage in corresponding holes of the plates, the hook entering the latching slot to engage in the base unit, and an operating member extending from the latch for driving the latch to slide between the plates; and
an elastic member connected with one fixing member of the latch for restoring the latch.

9. The latch mechanism as claimed in claim 8, wherein a sliding recess is defined in the cover unit for receiving the operating member sliding therein.

10. The latch mechanism as claimed in claim 8, wherein the cover unit comprises a first panel and a second panel, a through hole is defined in the second panel corresponding to the hook of the latch.

11. The latch mechanism as claimed in claim 8, wherein the elastic member receives said one fixing member therein, and two free ends of the elastic member respectively engage with the corresponding plate and the latch.

12. The latch mechanism as claimed in claim 8, wherein the fixing member is a rod.

13. The latch mechanism as claimed in claim 8, wherein the elastic member is a spring.

14. The latch mechanism as claimed in claim 8, wherein an engaging portion is formed from the latching slot of the base unit for engaging the hook of the latch.

15. An electronic device comprising:
a base unit of said electronic device;
a cover unit of said electronic device movably attachable to a side of said base unit, said cover unit movable relative to said base unit from a first position thereof to abut against said side of said base unit for covering thereon, and a second position thereof to move away for revealing said side of said base unit; and
a latch mechanism installable in a selective one of said base and cover units, and comprising a latch restorably movable inside and relative to said one of said base and cover units between a securing position thereof where said latch engages with the other of said base and cover units so as to secure said cover unit to said base unit in said first position of said cover unit, and a releasing position thereof where said latch disengages from said other of said base and cover units so as to release said cover unit to move to said second position thereof, said latch being movable in said one of said base and cover units by means of linear contact with said one of said base and cover units.

16. The electronic device as claimed in claim 15, wherein said latch abuts against a pair of curve-surfaced positioning blocks protruding from said one of said base and cover units for said linear contact when said latch moves inside said one of said base and cover units between said securing and releasing positions thereof.
